(19) United States
(12) Patent Application Publication
(10) Pub. No.: US 2005/0049102 A1
(43) Pub. Date: Mar. 3, 2005

(54) Hypocycloid reducing apparatus

(76) Inventor: Wen-Chan Hsieh, Kaohsiung (TW)

Correspondence Address: DAVID E. DOUGHERTY;DENNISON, SCHULTZ, DOUGHERTY & MACDONALD, 1727 KING STREET, SUITE 105, ALEXANDRIA, VA, 22314, US

(21) Appl. No.: 10/667,452

(22) Filed: Sep. 23, 2003

(30) Foreign Application Priority Data
Aug. 25, 2003 (TW) 092215367

(51) Int. Cl. F16H 3/70

(52) U.S. Cl. 475/169

(57) ABSTRACT

A hypocycloid reducing apparatus includes a hollow outside bracket, a hollow inside bracket and a driven input that is rotated by a rotating mechanism, such as a motor. The outside bracket has a passage with N quantity of lobe grooves. The inside is rotatably mounted in the passage of the outside bracket and has an inner space, M quantity of through holes and an output shaft. The through holes are arranged in an annular arrangement, are aligned with the lobe grooves and each through hole holds a roller. The driven input is mounted rotatably in the inner space and has an off-center assembly to encounter sequentially with each roller to actuate rotating the inside bracket. Therefore, a speed of revolution of the rotating mechanism is reduced to the output shaft. A volume of the reducing apparatus is minimized, as is noise produced during operation.

### BACKGROUND OF THE INVENTION

1. Field of the Invention

The present invention relates to a revolution reducing apparatus, and more particularly to hypocycloid reducing apparatus that is quiet and compact.

2. Description of Related Art

Reducing gears, also called reducers are typically coupled to motors for reducing revolution speeds of the motors. The reducers are widely used in many engineering designs. However, the reducers today are generally applied to gears, such as planetary gears to achieve a purpose of reducing revolutions of a rotating shaft. Although, the reducing gears can change the speed of rotation to a required speed of rotation for the rotating shaft, noises will be generated during a period of the gear operating. Besides, as an arrangement of the gears in the gear reducer always occupies a huge space, the gear reducer will be bulky.

A hypocycloid reducing apparatus works as a speed reduction and torque multiplier mechanism that is quiet, compact and durable. However, a hypocycloid reducing apparatus is not widely used in engineering designs because few mechanical engineers understand the design principle of the hypocycloid reducing apparatus.

To overcome the shortcomings, the present invention provides a hypocycloid reducing apparatus to mitigate or obviate the aforementioned problems.

### SUMMARY OF THE INVENTION

The main objective of the invention is to provide a hypocycloid reducing apparatus operating as a speed reduction and torque multiplier mechanism, wherein the hypocycloid reducing apparatus is quiet, compact and durable.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hypocycloid reducing apparatus in accordance with the present invention;

FIG. 2 is an operational cross sectional plan view of the hypocycloid reducing apparatus in FIG. 1 at rest;

FIG. 3 is a cross sectional view of the hypocycloid reducing apparatus along 3-3 line in FIG. 2;

FIG. 4 is an operational cross sectional plan view of the hypocycloid reducing apparatus in FIG. 1 wherein the hypocycloid reducing apparatus is mounted in a stationary base and is operating;

FIG. 5 is a cross sectional view of the hypocycloid reducing apparatus along 5-5 line in FIG. 4;

FIG. 6 is an operational cross sectional plan view of the hypocycloid reducing apparatus in FIG. 1 wherein the hypocycloid reducing apparatus is mounted in a wheel hub to drive a wheel;

FIG. 7 is a cross sectional view of the hypocycloid reducing apparatus along 7-7 line in FIG. 6 at rest;

FIG. 8 is an operational cross sectional plan view of the hypocycloid reducing apparatus in FIG. 6 wherein the hypocycloid reducing apparatus is operated; and

FIG. 9 is a cross sectional view of the hypocycloid reducing apparatus along 9-9 line in FIG. 8.

### DETAILED DESCRIPTION OF PREFERRED EMBODIMENT

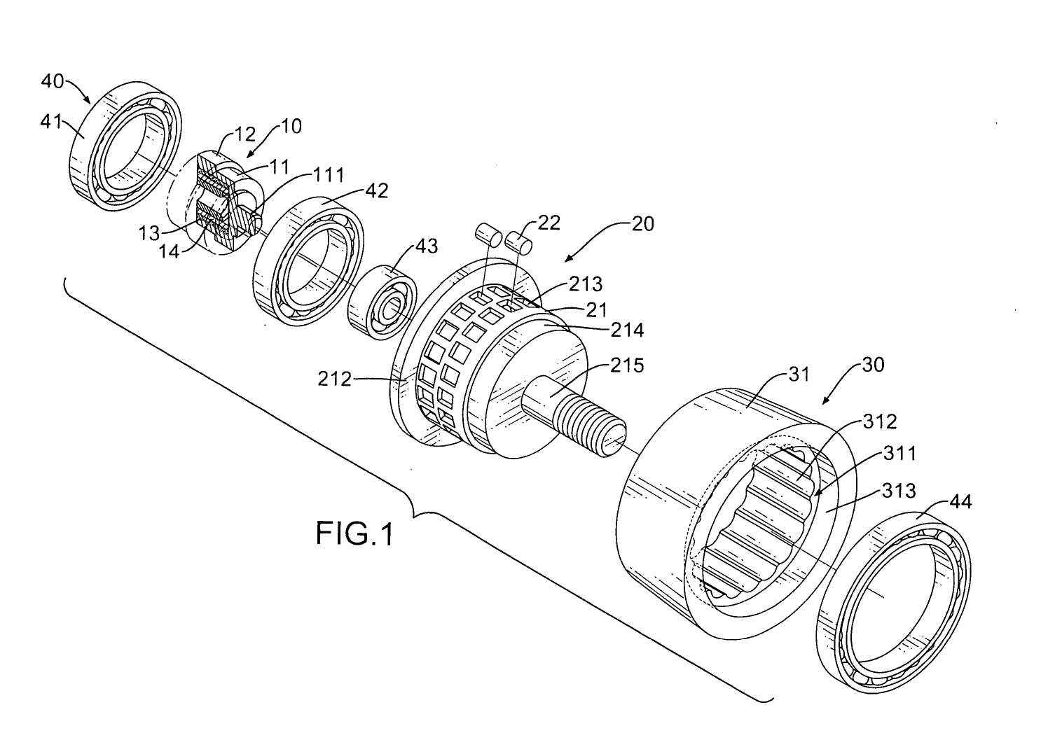

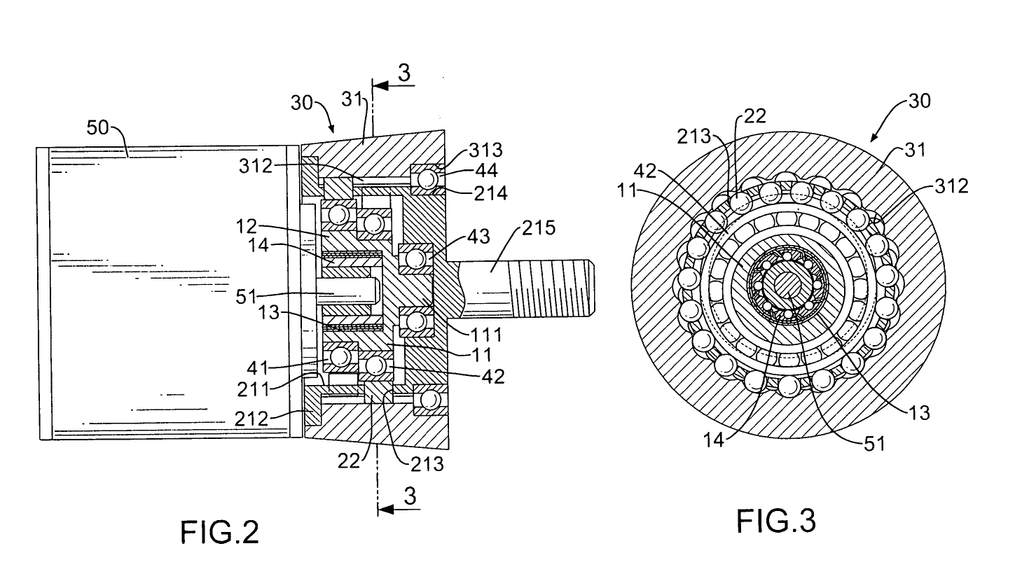

With reference to FIGS. 1 to 3, a hypocycloid reducing apparatus in accordance with the present invention is connected to a rotating mechanism, such as a motor (50) having a driving shaft (51), to reduce a speed of revolutions of the motor driving shaft (51). The hypocycloid reducing apparatus comprises a driven input (10), an inside bracket (20), an outside bracket (30) and multiple bearings (40) including a one-directional bearing (14). One of the inside bracket (20) and the outside bracket (30) is stationary, and the other is rotatable. For convenient illustrating purpose only, the inside bracket (20) is rotatable and the outside bracket (30) is stationary in the following description.

The driven input (10) is coupled to the driving shaft (51) of the motor (50) and is rotated by the driving shaft (51). The driven input (10) has a proximal end (not numbered), a distal end (not numbered), an off-center assembly (not numbered), a blind hole (13) and a pivot shaft (111). The off-center assembly comprises first and second off-center members (11, 12) that are circular and located in opposite to provide a dynamic balancing to the driven input (10) as the driven input (10) is rotated, and a first actuating bearing (42) and a second actuating bearing (41) that are respectively mounted on the first and the second off-center members (11, 12). The blind hole (13) is defined in the distal end of the driven input (10) to mount and hold the one-direction bearing (14) that is coupled to the driving shaft (51). Therefore, the driving shaft (51) only can rotate the driven input (10) in a given direction, and the one-directional bearing (14) will prevent the motor driving shaft (51) from being rotated in a reverse direction related to the given direction.

The driven input (10) is rotatably mounted in and held in the inside bracket (20) that is hollow and fitted with a bearing (43). The inside bracket (20) has a proximal end (not numbered), a distal end (not numbered), an inner space (211), an annular lip (212), multiple through holes (213), a bearing journal (214) and an output shaft (215). The inner space (211) is defined in the distal end of the inside bracket (20) to hold the driven input (10) with the bearings (41, 42, 43). The annular lip (212) is formed radially outward at the distal end of the inside bracket (20) and abuts rotatably the outside bracket (30). The through holes (213) are rectangular when viewed face on, are arranged into an annular arrangement including first and second annular configurations that are complementary and are aligned respectively with the first actuating bearing (42) and the second actuating bearing (41). Each through hole (213) receives an actuating roller, such as a cylinder (22) mounted rotatably in the through hole (213). The first and the second actuating bearings (42, 41) are respectively going to press sequentially one cylinder (22) in a corresponding of through holes (213) for an instant while the driven input (10) is rotated. The bearing journal (214) is formed near the proximal end of the inside bracket (20) to mount a bearing (44). The output shaft (215) is attached to the proximal end of the inside bracket (20).

The outside bracket (30) is hollow and has a passage (311) to mount co-axially the rotatable inside bracket (20). The outside bracket (30) further has a distal end (not numbered), a proximal end (not numbered), an interior periphery (not numbered) with multiple lobe grooves (312) and an annular bearing groove (313) formed near the proximal end of the outside bracket (30). The output shaft (215) extends out of the passage (311) through the proximal end of the outside bracket (30). The bearing (44) is mounted on the bearing journal (214) and is held in the annular bearing groove (313) to hold rotatably the inside bracket (20) in position.

Consequently, when the driven input (10) is rotated by the motor driving shaft (51) about a fixed axis of rotation, the actuating bearings (41, 42) that are respectively mounted on the off-center members (11, 12) will be rotated by the rotating driven input (10). Since the off-center members (11, 12) are not concentric and are located in opposite, the rotation of all the driven input (10) is dynamically balanced. The actuating bearings (42, 41) will encounter sequentially with one cylinder (22) in the through holes (213) at a time. The actuated cylinder (22) will be pressed sequentially to encounter with one of the lobe grooves (312) that will cause a reaction force to the cylinder (22) to rotate the inside bracket (20) about an axis of revolution. The actuating bearings (42, 41) will also diminish frictions during the actuating bearings (42, 41) encountering with the cylinders (22).

A speed reduction ratio can be calculated by a function of quantities of the cylinders (22) in one annular configuration and the lobe grooves (312). Supposing that M represents a quantity of the lobe grooves (312) and N represents a quantity of the cylinders (22) of each annular configuration, the speed reduction ration can be calculated by a fraction of a function of N and M, wherein the quantity of N is fewer than the quantity of M. In an optimized condition, the quantity of N is one fewer than the quantity of M.

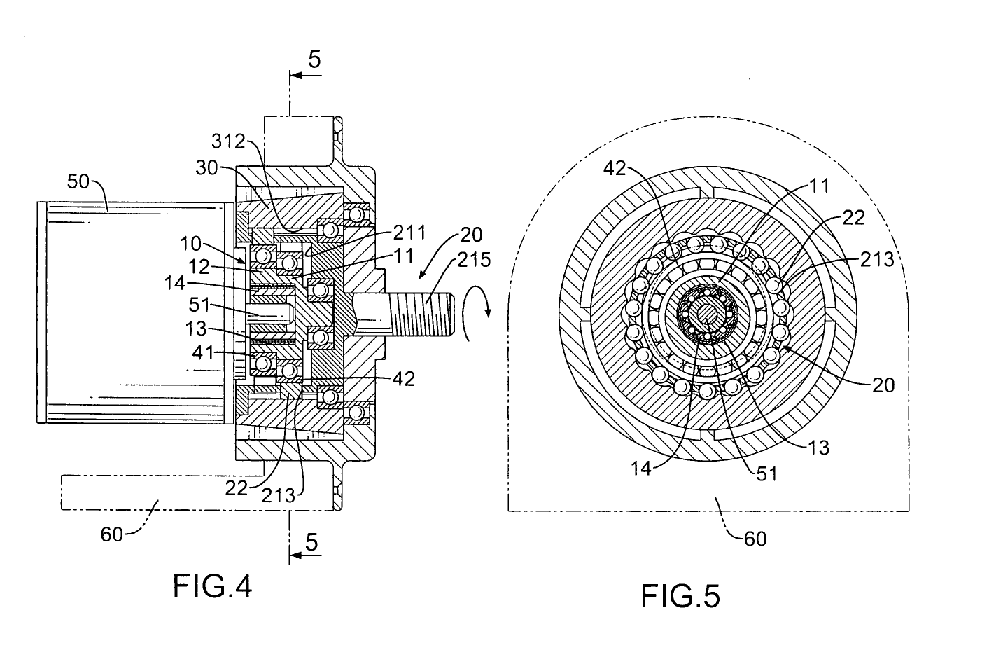

Consequently, in FIGS. 1, 4 and 5, the outside bracket (30) is fixed on a stationary base (60), and the quantity of N is equal to 19 and the quantity of M is equal to 20. Thus, the resultant speed reduction ratio is calculated to be −19. The negative sign signifies that the input and out output rotations are in opposite directions. In other words, revolutions of the driven input (10) are regarded as an input rotation and revolutions of the inside bracket (20) are regarded as an output rotation. The driven input (10) that is rotated by the motor driving shaft (51) rotates the inside bracket (20) in a direction opposite to the rotation of the driven input (10) at one-nineteenth the angular movement of the driven input (10). The output speed of revolution to the inside bracket (20) is reduced by the hypocycloid reducing apparatus.

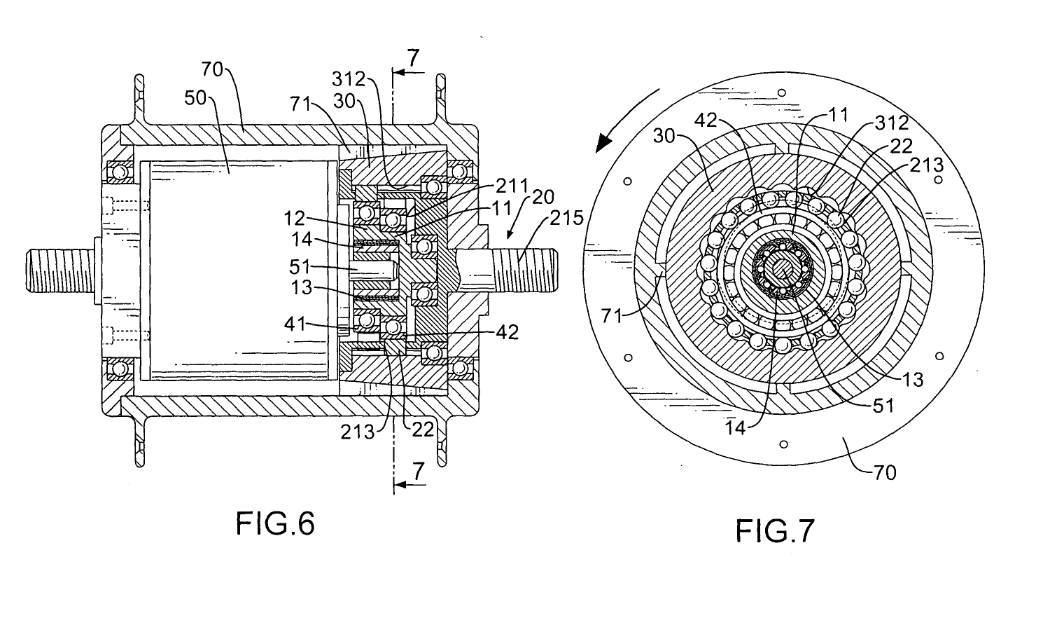

With reference to FIGS. 6 and 7, an opposite condition is shown in that the inside bracket (20) is stationary, the outside bracket (30) is rotatable and the hypocycloid reducing apparatus is applied to drive a motorized bicycle (not shown) and is mounted in a wheel hub (70). In such a state, the output shaft (215) is adapted to be mounted securely on a fork (not shown) of the bicycle and is fixed. The outside bracket (30) is clamped by four ribs (71) of the wheel hub (70) to drive the wheel hub (70) to rotate.

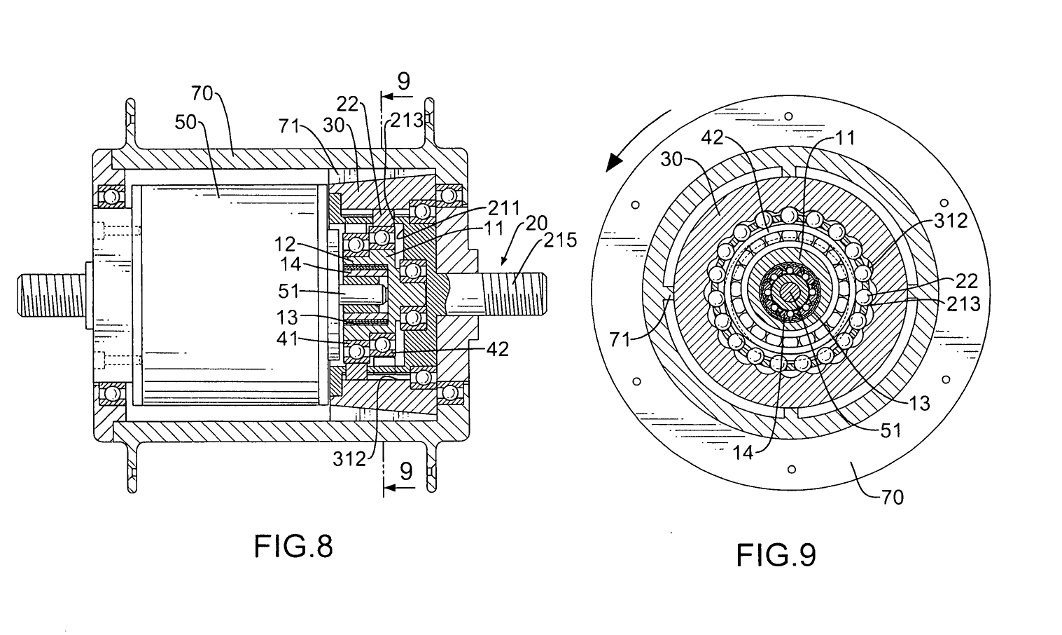

With reference to FIGS. 8 and 9, when the motor (50) starts to rotate the driving shaft (51) that rotates simultaneously the driven input (10) with the first and the second actuating bearings (42, 41), the two actuating bearings (41, 42) will encounter respectively one different cylinder (22) in sequence. Since the inside bracket (20) is fixed, the outside bracket (30) will be rotated with a reduced speed of rotation to drive the wheel hub (70) that will rotate a wheel (not shown) to move the bicycle.

Also, since the one-directional bearing (14) is mounted between the motor driving shaft (51) and the driven input (10), the one-directional bearing (14) will prevent the motor (50) from being reversed when the bicycle is moved physically by the rider, that is, turning the pedals of the bicycle. Thus, the one-directional bearing (14) prevents possible damage to the motor (50) that might otherwise be caused by reverse rotation of the driving shaft (51).

Because all parts of the hypocycloid reducing apparatus in accordance with the present invention are arrange co-axially about a given axis, a size of the whole hypocycloid reducing apparatus is compact. Power transmission in the hypocycloid reducing apparatus is by means of the actuating bearings (41, 42) and the cylinders (22) so that the hypocycloid reducing apparatus is quiet during a period of operation.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A hypocycloid reducing apparatus comprising:
an outside bracket being hollow and having a proximal end, a distal end and a passage with multiple lobe grooves defined from the proximal end to distal end;
an inside bracket with a proximal end and a distal end rotatably mounted in the passage of the outside bracket and having
an inner space defined in the distal end of the inside bracket;
multiple through holes arranged into an annular arrangement, corresponding to and aligned with the lobe grooves and each through hole holding rotatably an actuating roller; and
an output shaft attached to the proximal end of the inside bracket and extending out of the passage through the proximal end of the outside bracket; and
a driven input mounted rotatably in the inner space of the inside bracket and having an off-center assembly encountering sequentially with each of the rollers to press the encountered roller that is in a respective one of the through holes to encounter with a corresponding one of the lobe grooves;
wherein a quantity of the through holes is fewer than the quantity of the lobe grooves.

2. The hypocycloid reducing apparatus as claimed in claim 1, wherein the annular arrangement of the through holes has first and second annular configurations that are complementary, and the off-center assembly on the driven input has first and second off-center members that are located opposite to provide a dynamic balancing to the driven input, and the first and the second off-center members respectively encounter sequentially with a respective one of the rollers in the through holes of the first and the second annular configurations.

3. The hypocycloid reducing apparatus as claimed in claim 2, wherein the off-center assembly further comprises two actuating bearings mounted respectively on the first and the second off-center members to encounter with the actuating rollers.

4. The hypocycloid reducing apparatus as claimed in claim 1, wherein the through holes are rectangular in cross section, and the actuating rollers are cylinders.

5. The hypocycloid reducing apparatus as claimed in claim 2, wherein the through holes are rectangular in cross section, and the actuating rollers are cylinders.

6. The hypocycloid reducing apparatus as claimed in claim 3, wherein the through holes are rectangular in cross section, and the actuating rollers are cylinders.

7. The hypocycloid reducing apparatus as claimed in claim 6, wherein the inside bracket further has an annular lip formed radially at the distal end of the inside bracket and abuts rotatably the distal end of the outside bracket.

8. The hypocycloid reducing apparatus as claimed in claim 7, wherein the inside bracket further has a bearing journal formed near the proximal end of the inside bracket, the outside bracket further has an annular bearing groove formed near the proximal end of the outside bracket and aligned with the bearing journal, and a bearing is mounted on the bearing journal in the bearing groove to hold the inside bracket in position.
